(19) United States
(12) Patent Application Publication
(10) Pub. No.: US 2008/0278603 A1
(43) Pub. Date: Nov. 13, 2008

(54) METHOD AND APPARATUS FOR REDUCING FLICKER OF IMAGE SENSOR

(75) Inventors: Chang-woo LEE, Suwon-si (KR); Dong-bum Choi, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/865,561

(22) Filed: Oct. 1, 2007

(30) Foreign Application Priority Data
May 7, 2007 (KR) 10-2007-0044230

(51) Int. Cl. H04N 9/73

(52) U.S. Cl. 348/226.1; 348/E09.051

(57) ABSTRACT

Provided is a method and apparatus for reducing flickers of an image sensor capable of reducing line flickers due to a complementary metal-oxide-semiconductor (CMOS) sensor. The method includes: estimating a profile of a light source per line on the basis of information on image frames which are continuously input; filtering information of the estimated profile of the light source with a predetermined bandwidth; normalizing the filtered information of the estimated profile of the light source, and extracting a correction gain per line; and selecting the correction gain per line repeated in units of predetermined frames, and applying the correction gain to an input image signal.

### CROSS-REFERENCE TO RELATED PATENT APPLICATION

This application claims priority from Korean Patent Application No. 10-2007-0044230, filed on May 7, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to reducing flickers of an image sensor, and more particularly, to reducing line flicker due to a complementary metal-oxide-semiconductor (CMOS) sensor.

2. Description of the Related Art

In general, a video camera electrically records two dimensional (2D) information about an object. The video camera converts an optical image of the object into an electric signal, stores the electric signal in a memory, reads an image stored in the memory as needed, and print the image or transmit the image to a computer.

The video camera uses an image sensor in order to convert an optical image into an electric signal. The image sensor conventionally uses a charge-coupled device (CCD) or a complementary metal-oxide-semiconductor (CMOS).

Light sources used by the CMOS image sensor are mainly classified into sunlight and artificial light. The artificial light is usually generated from fluorescent lamps and incandescent lamps. A frequency of an alternating current (AC) power source used for the fluorescent lamp differs by countries, and most countries use 50 Hz and 60 Hz.

The CMOS image sensor includes a pixel unit for capturing an image and a signal processor for processing image information generated by the pixel unit. The pixel unit forms an image by using tens to millions of pixels. When the pixels are exposed to light in order to capture an image, not all pixels are exposed at one time due to the concern of leakage current. Therefore, the CMOS image sensor sequentially exposes the pixels per line. Here, in an image sensor having 800×600 pixels, a row in which 800 unit pixels are arrayed becomes a line.

FIG. 1A shows a rolling shutter timing diagram which occurs in a CMOS sensor.

A frame includes a plurality of lines Line 1 to Line N. A frame time is 1/60 second.

The CMOS sensor applies light intensities, which are accumulated by integration in a unit of a line, to a practical image. Each line interval time is 2.3 microseconds.

An integration time per line of the CMOS sensor is 16.7 microseconds, which is the same as a maximum frame time. The integration time is controlled using a line 102.

Here, when an exposure time per line of an image sensor is not an integer multiple of the period of the frequency of a power source used for a fluorescent lamp, flicker noise occurs in an output image. For example, when an image is captured at 60 Hz under lighting of a fluorescent lamp driven by a power source frequency of 50 Hz, light intensities per line of the object are different from each other.

FIG. 1B is a timing diagram showing a flicker phenomenon per line that occurs in an output image of the CMOS sensor.

Referring to FIG. 1B, the power source frequency of the fluorescent lamp is 50 Hz (denoted by 104), and a frequency used to capture an image signal is 60 Hz (denoted by 103). The fluorescent lamp emits light with alternating inverted positive and negative voltages. Therefore, the practical light source reflecting from an object has a light intensity change frequency of 100 Hz (denoted by 105). A numeral 107 shows a light intensity per line that changes when the light intensity of the fluorescent lamp is accumulated. Here, the same light intensity in units of three frames is repeated per line.

Therefore, in a related art, in order to remove flicker noise, the exposure time has to be set to be an integer multiple of the period of the light source frequency. However, as described above, since the frequency period differs by a fluorescent lamp, there is an inconvenience of setting a frequency to a specific AC power source by a user subject to a light source.

### SUMMARY OF THE INVENTION

The present invention provides a method and apparatus for reducing flickers of an image sensor in a video camera system, which are capable of effectively decreasing line flicker noise by performing inverse calibration on an image signal by using information on a light source.

The present invention also provides a video camera system applying the method and apparatus for reducing flickers of an image sensor.

According to an aspect of the present invention, there is provided a method of reducing flickers of an image sensor, including: estimating a profile of a light source per line on the basis of continuously input image information on a frame; performing filtering on the estimated profile information on the light source with a predetermined bandwidth; normalizing the filtered profile information on the light source and extracting a correction gain per line; and selecting the correction gain per line repeated in units of predetermined frames and applying the correction gain to an input image signal.

According to another aspect of the present invention, there is provided a video camera system including: an image capture device capturing an image of an object formed on a plane of incidence to output a corresponding analog red/green/blue (RGB) signal; an analog signal processor performing auto gain control on the analog RGB signal output from the image capture device by AGC (auto gain control); an analog-digital converter converting the RGB analog signal output from the analog signal processor into an RGB digital signal; and a digital signal processor estimating a profile of a light source per line on the basis of RGB signals of a plurality of frames output from the analog-digital converter, extracting a correction gain per line by using the estimated profile information on the light source, and applying the correction gain to the RGB signal.

### BRIEF DESCRIPTION OF THE DRAWINGS

The above and other aspects of the present invention will become more apparent by describing in detail exemplary embodiments thereof with reference to the attached drawings, in which:

FIG. 1A shows rolling shutter timing effect which occurs in a complementary metal-oxide-semiconductor (CMOS) sensor;

FIG. 1B is a timing diagram showing a flicker phenomenon per line that occurs in an output image of a CMOS sensor;

FIG. 2 is a block diagram showing a video camera system employing an apparatus for reducing flickers according to an exemplary embodiment of the present invention;

FIG. 3 is a detailed block diagram showing the apparatus for reducing flickers performed in a digital signal processor shown in FIG. 2, according to an exemplary embodiment of the present invention;

FIG. 4A is a graph for explaining an exemplary embodiment of generating a light source profile, which is performed in a light source profile calculator shown in FIG. 3, according to an exemplary embodiment of the present invention;

FIG. 4B is a graph showing a difference value per line obtained from an experimental image, according to an exemplary embodiment of the present invention.

FIG. 5A shows a light flicker image due to a rolling shutter effect of a CMOS sensor when a light source frequency and an image capture frequency are different from each other, according to an exemplary embodiment of the present invention;

FIG. 5B shows a waveform of a light source accumulating line data obtained by a light source profile calculator and a low pass filter (LPF), according to an exemplary embodiment of the present invention;

FIG. 6A is a graph for obtaining a correction gain per line using a normalization unit shown in FIG. 3, according to an exemplary embodiment of the present invention;

FIG. 6B shows an image having been applied a correction gain per line thereto, according to an exemplary embodiment of the present invention;

FIG. 7 is a conceptual diagram showing a method of reducing flickers according to an exemplary embodiment of the present invention; and

FIG. 8 is a flowchart showing a method of reducing flickers of an image sensor according to an exemplary embodiment of the present invention.

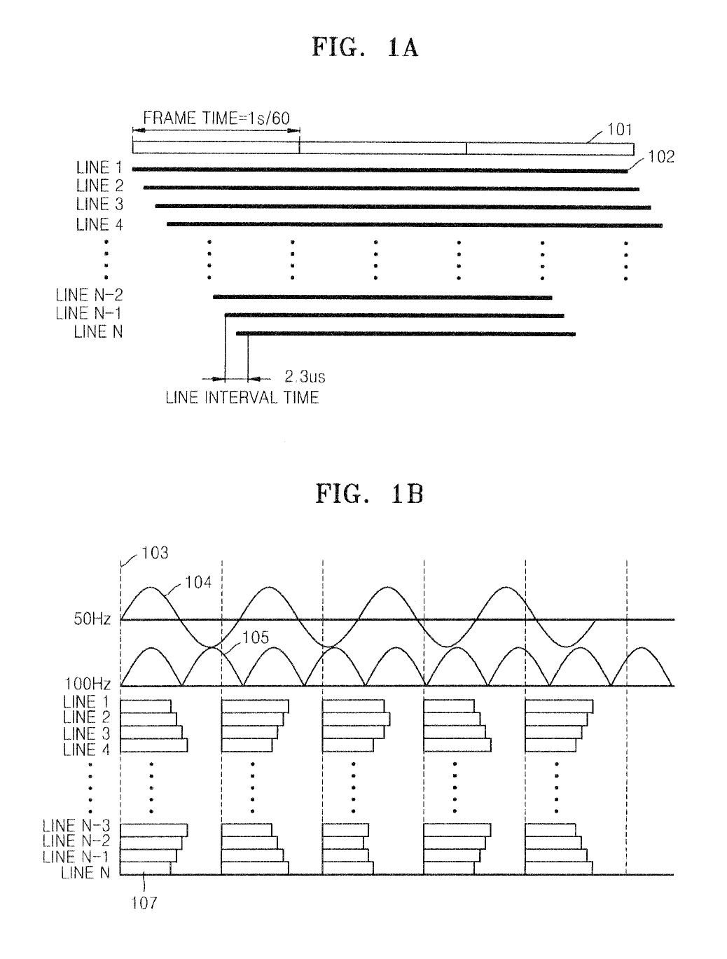

### DETAILED DESCRIPTION OF EXEMPLARY EMBODIMENTS

Hereinafter, exemplary embodiments of the present invention will be described in detail with reference to the attached drawings.

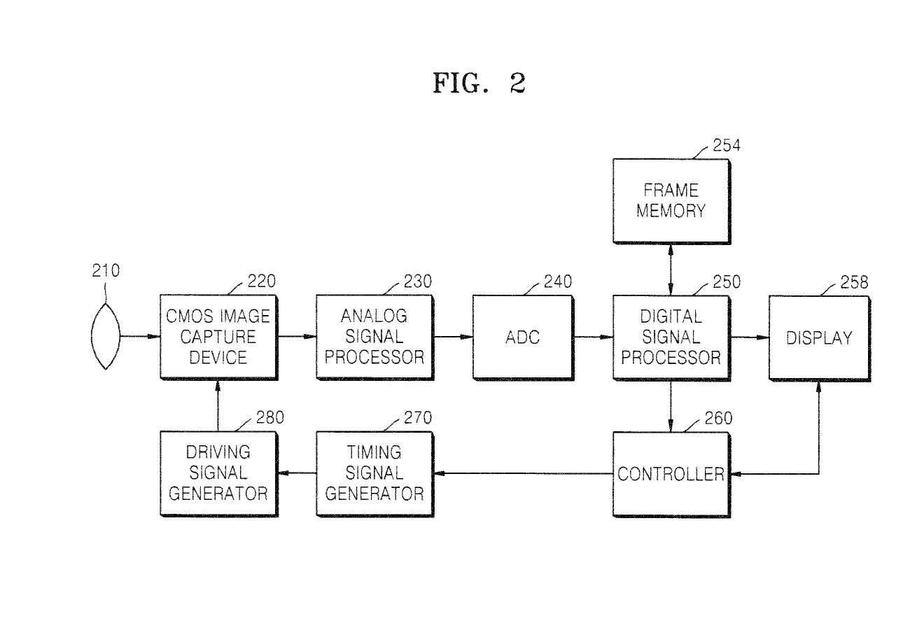

FIG. 2 is a block diagram showing a video camera system employing an apparatus for reducing flickers according to an exemplary embodiment of the present invention.

The video camera system of FIG. 2 includes a photographing lens 210, a complementary metal-oxide-semiconductor (CMOS) image capture device 220, an analog signal processor 230, an analog-digital converter (ADC) 240, a digital signal processor 250, a frame memory 254, a display 258, a controller 260, a timing signal generator 270, and a driving signal generator 280.

The photographing lens 210 forms an image of an object to be photographed on a plane of incidence of the CMOS image capture device 220.

The CMOS image capture device 220 captures the image of the object formed on the plane of incidence in order to output a corresponding analog RGB signal.

The analog signal processor 230 performs correlated double sampling on the analog RGB signal generated by the CMOS image capture device 220, and automatically controls a gain of the RGB analog signal through auto gain control (AGC). For example, when the object is bright and a signal level is high, the analog signal processor 230 decreases an AGC gain, and when the object is dark and the signal level is low, the analog signal processor 230 increases the AGC gain.

The ADC 240 converts the RGB analog signal output from the analog signal processor 230 into an RGB digital signal.

The digital signal processor 250 reduces noise in the RGB digital signal output from the ADC 240 by using a noise reduction algorithm having functions of definition correction, color correction, gamma correction, flicker reduction, and the like, converts the RGB digital signal into a YCbCr signal for display, and generates a horizontal and vertical synchronization signal.

In particular, the digital signal processor 250 estimates a profile of a light source per line on the basis of information on image frames which are continuously input, extracts a correction gain per line by using the estimated profile information on the light source, and applies the correction gain to the input image signal. The digital signal processor 250 perceives periodicity of the input image signal, calculates a correction gain only for an image signal of a first period, and corrects an image signal of a next period by using a corresponding correction gain according to the periodicity.

The frame memory 254 stores an RGB signal of a frame processed by the digital signal processor 250.

The display 258 may be constructed using a liquid crystal display (LCD) and displays the YCbCr signal output from the digital signal processor 250.

The controller 260 passes the horizontal and vertical synchronization signal generated by the digital signal processor 250 to the timing signal generator 270, controls each function operation according to an operation instruction of a user, and displays a setup state or a control state of a camera on the display 258.

The timing signal generator 270 generates a timing signal according to the horizontal and vertical synchronization signal output from the controller 260.

The driving signal generator 280 generates a driving signal for driving an image capture operation of the CMOS image capture device 220 according to the timing signal generated by the timing signal generator 270.

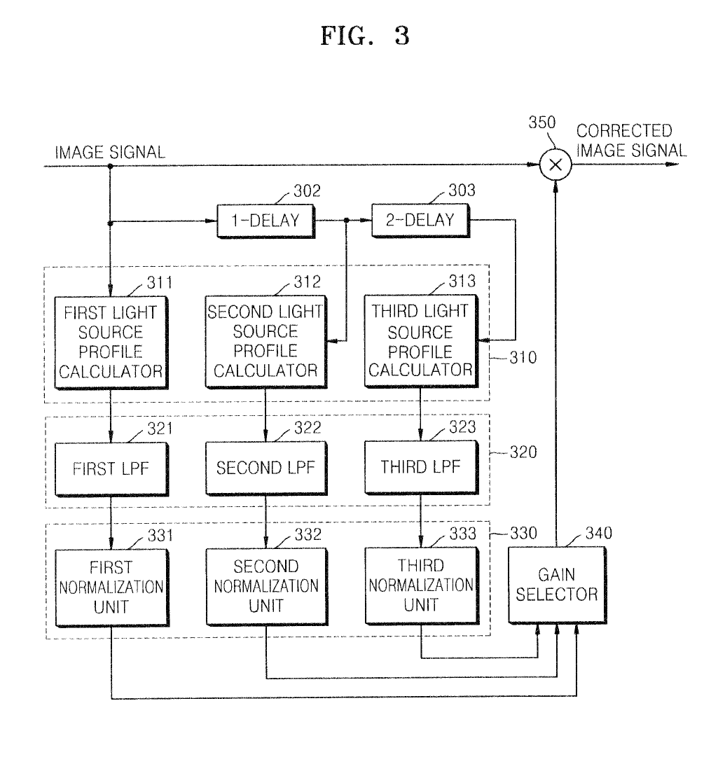

FIG. 3 is a detailed block diagram showing an apparatus for reducing flickers performed in the digital signal processor shown in FIG. 2.

The apparatus for reducing flickers includes first and second display units 302 and 303, a light source profile calculator 310, a low pass filter (LPF) 320, a normalization unit 330, a gain selector 340, and a multiplier 350.

A light source frequency and a frame capture frequency are repeated in units of three frames. Therefore, the apparatus for reducing flickers according to the current exemplary embodiment of the present invention performs signal processing only on three frames.

First, an RGB image signal or a YCbCr signal in a unit of a frame is input. The first delay unit 302 delays the input image signal of the frame for a predetermined time. The second delay unit 303 delays the image signal of the frame output from the first delay unit 302 for a predetermined time.

The light source profile calculator 310 estimates a profile of the light source per line based on information on frames, and estimates a rate of change of a light intensity per line.

The light source profile calculator 310 includes first, second, and third light source profile calculators 311, 312, and 313 in order to process image signals of the three frames.

The first light source profile calculator 311 estimates a light source profile per line from an image signal of a first frame. The second light source profile calculator 312 estimates a light source profile per line from an image signal of a second frame output from the first delay unit 302. The third light source profile calculator 313 estimates a light source profile per line from an image signal of a third frame output from the second delay unit 303.

According to an exemplary embodiment, the light source profile calculator 310 divides difference values of pixels between lines in a corresponding frame by an average value of a pixel between the lines, multiplies the divided difference values by a scaling factor to calculate a histogram, and estimates a scaling value when a frequency in the histogram reaches a maximum as the rate of change of the light intensity of a corresponding line.

Here, the rate of change of the light intensity per line is a result of estimation from an image signal. Therefore, significant change or impulse noise of the object has to be removed by low pass filtering.

The LPF 320 performs low pass filtering on the maximum value of the profile of the light source estimated by the light source profile calculator 310 in order to increase reliability of an image. Here, the LPF 320 includes first, second, and third LPFs 321, 322, and 323 in order to process the image signals of the three frames, respectively.

The first LPF 321 performs low pass filtering on the light source profile information output from the first light source profile calculator 311. The second LPF 322 performs low pass filtering on the light source profile information output from the second light source profile calculator 312. The third LPF 323 performs low pass filtering on the light source profile information output from the third light source profile calculator 313.

According to another exemplary embodiment, instead of the LPF 320, in consideration of characteristics of a light intensity change, the following low pass filtering method depending on the light intensity is performed. Here, the characteristics of the light intensity change can be perceived by a type of data having a maximum frequency in the histogram.

If (Line gain F_gain_F[i]!=Line_gain[i−1]||Line_gain[i+1])

Line_gain_F[i]=(Line_gain[i−1]+(Line_gain[i+1])/2

else

Line_gain_F[i]=Line_gain[i],

where, Line_gain F[i] is a current line gain value, Line_gain[i−1] is a previous line gain value, and Line_gain[i+1] is a next line gain value.

The normalization unit 330 adds or subtracts a minimum value of the profile to or from the filtered profile value of the light source to remove a negative number, and inverts the obtained value.

Here, the normalization unit 330 includes first, second, and third normalization units 331, 332, and 333 in order to process the images of the three frames.

Therefore, the normalization unit 330 normalizes the filtered profile value of the light source by using the minimum value of the profile, and obtains a correction line gain to be applied to a practical image signal.

The gain selector 340 selects a gain of lines repeatedly output from the normalization unit 330 in units of three frames.

The multiplier 350 generates a corrected image signal by multiplying the line gain value selected by the gain selector 340 by an input image signal.

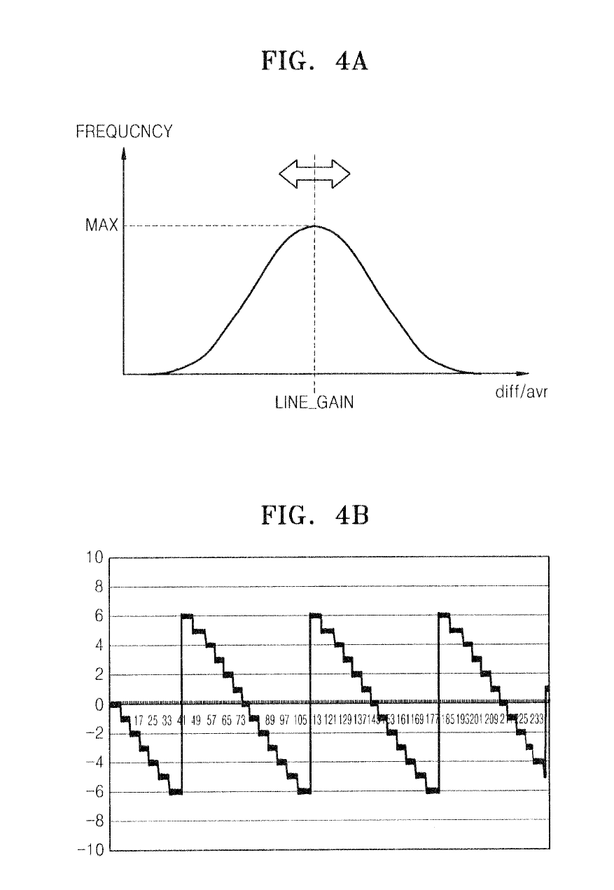

FIG. 4A is a graph for explaining an exemplary embodiment of generating a light source profile, which is performed in the light source profile calculator 310 shown in FIG. 3.

FIG. 4A shows a graph for a light source profile. Here, the y-coordinate is a frequency, and the x-coordinate is a difference value of pixels between lines divided by an average value pixels between the lines. Here, a rate of change of the light intensity for a corresponding line is extracted by multiplying the difference value by a scaling factor. In addition, a scaling value, when the frequency of the difference value becomes the maximum, is extracted as the rate of change of the light intensity of the corresponding line.

FIG. 4B is a graph showing a difference value per line obtained from an experimental image. Here, the x-coordinate is a line number, and the y-coordinate is the difference value.

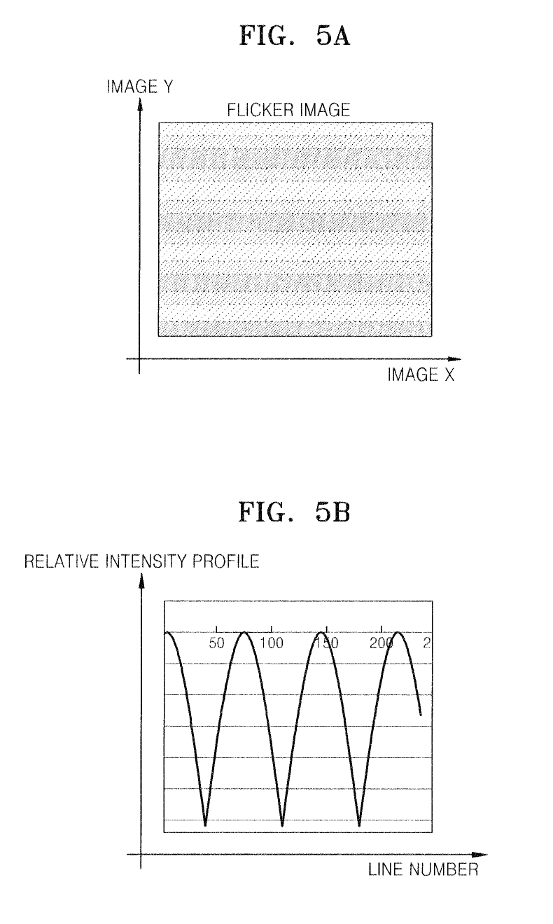

FIG. 5A shows a light flicker image due to a rolling shutter effect of a CMOS sensor when a light source frequency and an image capture frequency are different from each other. A change in brightness in part of an image is shown.

FIG. 5B shows a waveform of a light source accumulating line data obtained by the light source profile calculator 310 and the LPF 320. A flicker image generated due to lighting of 100 Hz is estimated as a profile of the light source by using the light source profile calculator 310 and the LPF 320. Comparing FIGS. 5A and 5B with each other, it can be seen that a luminance change per line of the image and the estimated profile value are the same.

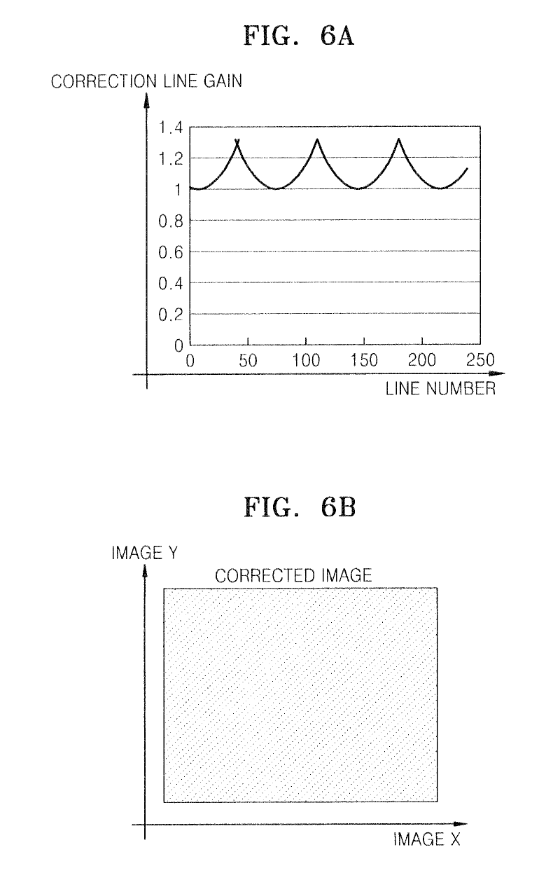

FIG. 6A is a graph for obtaining a correction gain per line using the normalization unit 330 shown in FIG. 3.

Referring to FIG. 6A, in order to obtain a correction gain to be applied to a practical image signal, a minimum value of a profile of a light source of 50 Hz is added to or subtracted from the profile value, and the obtained value is inverted. A correction gain per line is extracted from the normalized light source profile. For example, for a dark part of an image, a large correction gain is applied to corresponding lines, and for a bright part of the image, a small correction gain is applied to corresponding lines.

FIG. 6B shows an image having been applied a correction gain per line thereto. When the flicker image shown in FIG. 5A and the corrected image shown in FIG. 6B are compared with each other, it can be seen that flicker noise is reduced. Therefore, a gain of an image signal is controlled in a unit of a line by using the profile of the light source, so that a line light intensity is steadily maintained.

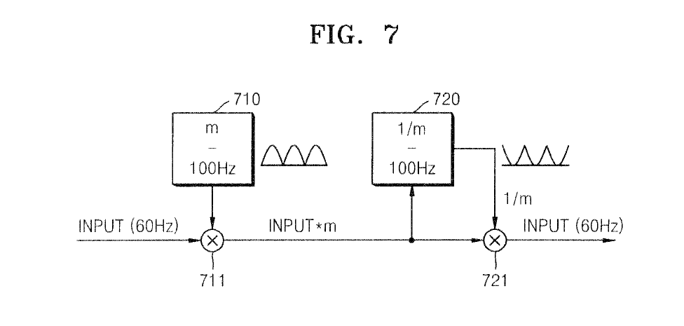

FIG. 7 is a conceptual diagram showing a method of reducing flickers according to an exemplary embodiment of the present invention.

A first multiplier 711 multiplies a light signal m of a fluorescent lamp 710 having a light source of 100 Hz by an image signal (referred to as an input) having an image capture frequency of 60 Hz. Here, since a light intensity varies per line, the image signal has a different gain value per line.

A flicker reduction unit 720 estimates a light source profile from the image signal captured under lighting of the fluorescent lamp, and extracts a correction gain corresponding to an inverse number of the profile.

A second multiplier 721 multiplies the correction gain value per line output from the flicker reduction unit 720 by the image signal to output a corrected image signal.

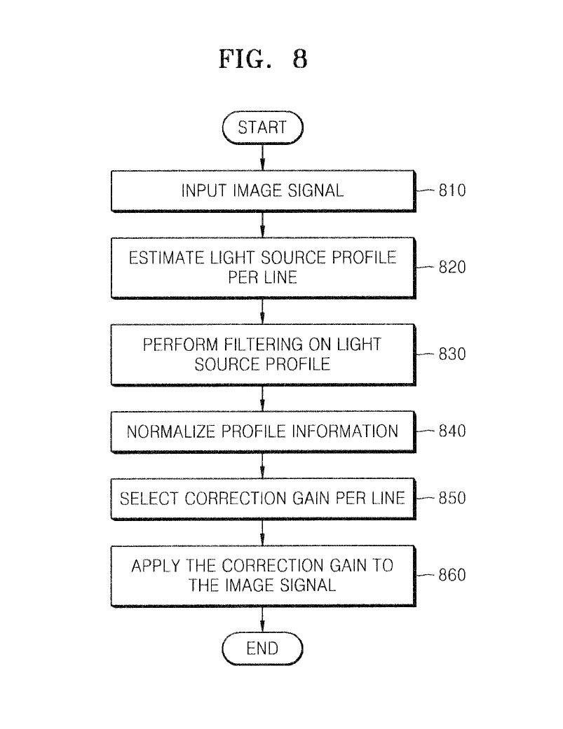

FIG. 8 is a flowchart showing a method of reducing flickers of an image sensor according to an exemplary embodiment of the present invention.

First, an RGB image signal or a YCbCr image in a unit of a frame signal is continuously input (operation 810).

Next, on the basis of information on image frames which are continuously input, a profile of a light source per line is estimated (operation 820). In particular, the profile of the light source is estimated by using a histogram that shows a frequency of a pixel difference value between lines. Here, the profile of the light source represents a rate of change of the light intensity.

Next, low pass filtering is performed on a maximum value of the estimated profile of the light source (operation 830).

Next, normalization is performed on the filtered profile information on the light source to extract a correction gain per line (operation 840).

Next, a correction gain is selected per line that is repeated in units of three frames, and the selected correction gain is multiplied by the input image signal (operation 860).

As described above, when an image capture frequency of a camcorder having a CMOS sensor and a light source frequency of a fluorescent lamp are different from each other, line flickers that occur due to an integration change of shutter per line can be reduced. For example, flicker noise, that can occur when a video signal having a frequency of 60 Hz is filmed under lighting of a fluorescent lamp having a light source frequency of 50 Hz, can be removed. Therefore, line flicker noise due to the CMOS sensor can be decreased regardless of a frequency of an external light source, and therefore an image quality can be improved.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A method of reducing flickers of an image sensor, comprising:
estimating a profile of a light source per line on the basis of information on image frames which are continuously input;
filtering information of the estimated profile of the light source with a predetermined bandwidth;
normalizing the filtered information of the estimated profile of the light source, and extracting a correction gain per line; and
selecting the correction gain per line, and applying the correction gain to an input image signal,
wherein the correction gain per line is repeated in units of predetermined frames.

2. The method of claim 1, wherein estimating the profile of the light source comprises calculating a rate of change of a light intensity per line on the basis of pixel information on the image frames.

3. The method of claim 2, wherein the calculating a rate of change of a light intensity per line comprises:
dividing a difference value of pixels between lines in an image frame by an average value of the pixels between the lines;
calculating a histogram by multiplying the divided difference value by a scaling factor; and
estimating a scaling value when a frequency in the histogram reaches a maximum as a rate of change of a light intensity of a corresponding line.

4. The method of claim 3, wherein the filtering comprises low pass filtering a maximum value in the histogram.

5. The method of claim 3, wherein the filtering comprises performing dependent low pass filtering according to a type of data having a maximum frequency of the histogram.

6. The method of claim 5, wherein in performing the dependent low pass filtering, when a gain of a current line is not the same as a gain of a previous line or a gain of a next line, the gain of the current line is set as a value of an average of the gain of the previous line and the gain of the next line, and when the gain of the current line is the same as the gain of the previous line or the gain of the next line, the gain of the current line is not changed.

7. The method of claim 1, wherein the normalizing comprises:
adding or subtracting a minimum value of the profile of the light source to or from a value of the profile to remove a negative number; and
inversing a value obtained by the adding or subtracting.

8. The method of claim 1 further comprising determining periodicity of the input image signal,
wherein the input signal is an input signal of a first period, and
wherein, if the periodicity is determined, the correction gain is calculated only for the input image signal of the first period, and an input image signal of a next period is corrected using a correction gain corresponding to the periodicity.

9. An apparatus of reducing flickers of an image sensor, comprising:
a light source profile calculator which estimates a profile of a light source per line on the basis of information on image frames which are continuously input;
a filter which filters information of the estimated profile of the light source with a predetermined bandwidth;
a normalization unit which normalizes the filtered information of the estimated profile of light source, and extracts a correction gain per line; and
a gain selector which selects the correction gain per line, and applies the correction gain to an input image signal,
wherein the correction gain per line is repeated in units of predetermined frames.

10. The apparatus of claim 9, wherein the light source profile calculator divides a difference value of pixels between lines in an image frame by an average value of the pixels between the lines, calculates a histogram by multiplying the divided difference value by a scaling factor, and estimates a scaling value when a frequency in the histogram reaches a maximum as a rate of change of a light intensity of a corresponding line.

11. The apparatus of claim 1, wherein the filter is a low pass filter.

12. A video camera system comprising:
an image capture device which captures an image of an object formed on a plane of incidence to output a corresponding analog red/green/blue (RGB) signal;
an analog signal processor which performs auto gain control on the analog RGB signal;
an analog-digital converter which converts the RGB analog signal output from the analog signal processor into an RGB digital signal; and
a digital signal processor which estimates a profile of a light source per line on the basis of RGB signals of a plurality of frames output from the analog-digital converter, extracts a correction gain per line by using the estimated profile on the light source, and applies the correction gain to the RGB signal.

13. The system of claim 12, wherein the digital signal processor comprises:
a light source profile calculator which estimates the profile of the light source per line on the basis of information on image frames which are continuously input;
a filter which performs low pass filtering on information of the estimated profile of the light source;
a normalization unit which normalizes the information of the estimated profile of the light source on which the low pass filtering is performed to detect a correction gain per line;
a gain selector which selects the correction gain per line, which is repeated in units of predetermined frames; and
a multiplier which applies the selected correction gain per line to an input image signal.
